(19) United States
(12) Patent Application Publication
(10) Pub. No.: US 2007/0275848 A1
(43) Pub. Date: Nov. 29, 2007

(54) MANUFACTURING PROCESS AND STRUCTURE OF MEMBRANE ELECTRODE ASSEMBLY LAYER FOR FUEL CELL

(76) Inventors: HSI-MING SHU, Taipei (TW); Tsang-Ming Chang, Taipei (TW); Kd-Chen Shen, Taipei (TW)

Correspondence Address: G. LINK CO., LTD, 3550 BELL ROAD, MINOOKA, IL, 60447, US

(21) Appl. No.: 11/419,923

(22) Filed: May 23, 2006

(51) Int. Cl. H01M 4/88; B05D 5/12; H01M 4/94

(52) U.S. Cl. 502/101; 427/115; 429/44

(57) ABSTRACT

The present invention is disclosed a manufacturing process and a structure of MEA layer for fuel cell. In the present invention, it forms a rigid support to proton exchange membrane with racks that are separately pasted on the upper an lower surface of it, and the area outside where the racks are pasted is defined as the second areas. Catalyst and diffusion layers are formed on the second areas of the upper and lower surface of the proton exchange membrane by means of Nafion solution manufacturing process, which finally forms the MEA layer for electrochemical reaction of the fuel cell on the second area of the proton exchange membrane.

### FIELD OF THE INVENTION

The present invention relates to a manufacturing process and a structure of membrane electrode assembly (MEA) layer for fuel cell, particularly relates to forming MEA layer for the electrochemical reaction of fuel cell on part of proton exchange membrane.

### BACKGROUND OF THE INVENTION

There is a kind of fuel cell with a structure of base plate in prior art. It concludes a cell core providing power with electrochemical reaction as well, wherein the cell core is chiefly a MEA layer. It applies the Nafion solution provided by Dupont Company to form the MEA layer for electrochemical reaction generally in this kind of fuel cell, by means of forming catalyst and diffusion layer on a soft proton exchange membrane. The above-said proton exchange membrane is made from absorbent material. There will be a deformation of proton exchange membrane caused by the area difference between saturated and unsaturated of water, which will shift the position of the MEA layer and further cause problem in assembly because of inaccurate locating of the MEA layer.

### SUMMARY OF THE INVENTION

The present invention provides a manufacturing process and a structure of MEA layer for fuel cell to solve one or more problems in prior art mentioned above.

The main object of the present invention is to provide a manufacturing process and a structure of MEA layer for fuel cell, which forms two fixed racks for proton exchange membrane to prevent its deformation that causes the position shift of MEA layer.

To achieve the object mentioned above, the present invention provides a manufacturing process and a structure of MEA layer for fuel cell. It forms a rigid support to proton exchange membrane with racks being separately pasted on the upper an lower surface of it, and the area outside where the racks are pasted is defined as the second area. The catalyst and diffusion layers are formed on the second areas of the upper and lower surface of the proton exchange membrane by means of Nafion solution manufacturing process, which finally forms the MEA layer for electrochemical reaction of the fuel cell on the second areas of the proton exchange membrane.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is the flow diagram of a preferred embodiment of the present invention;

FIGS. 2a to 2c are skeleton drawings of the structure achieved by the manufacturing process in FIG. 1;

FIG. 3 is the flow diagram of another preferred embodiment of the present invention.

FIGS. 4a to 4c are skeleton drawings of the structure achieved by the manufacturing process in FIG. 3; and

FIG. 5 is the structural section of the MEA layer for fuel cell in present invention.

### DETAILED DESCRIPTION OF THE INVENTION

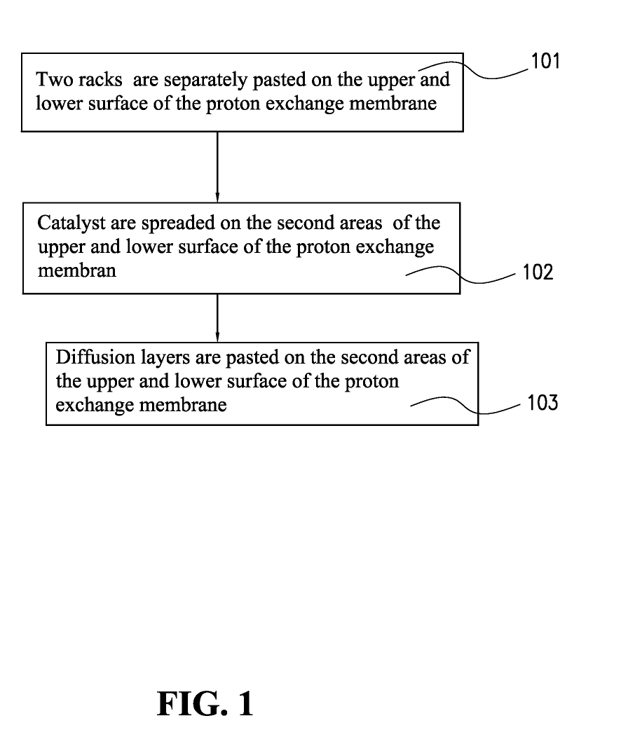

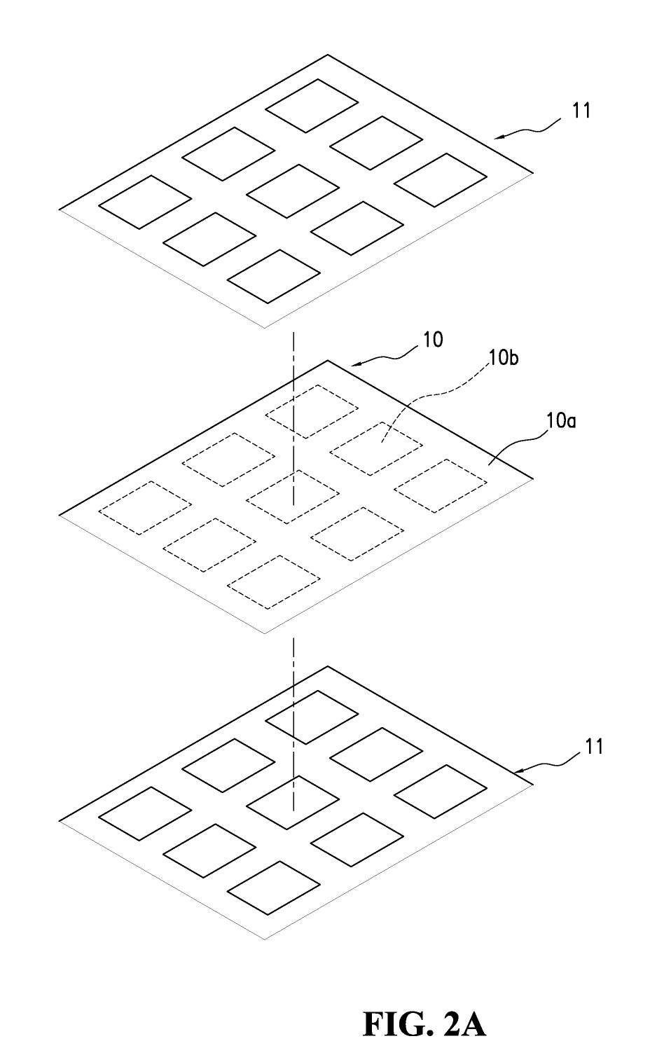

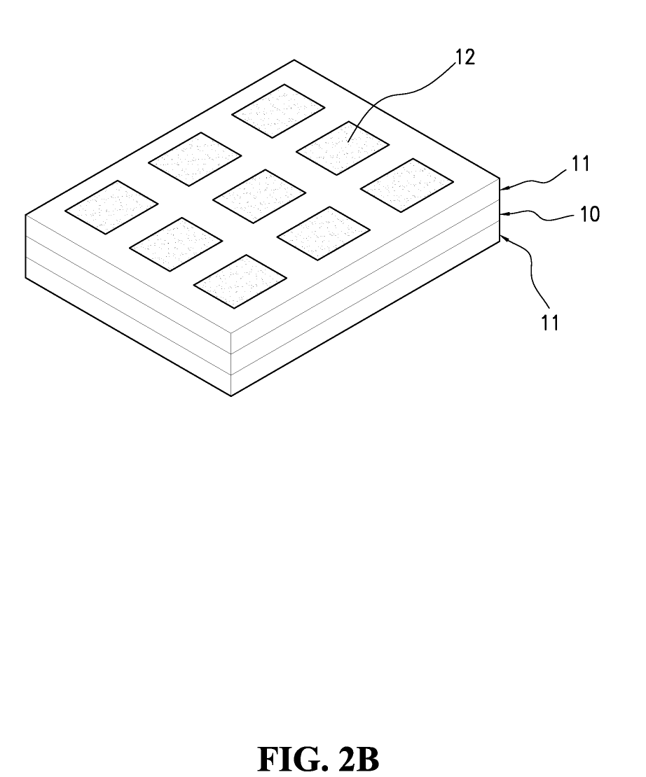

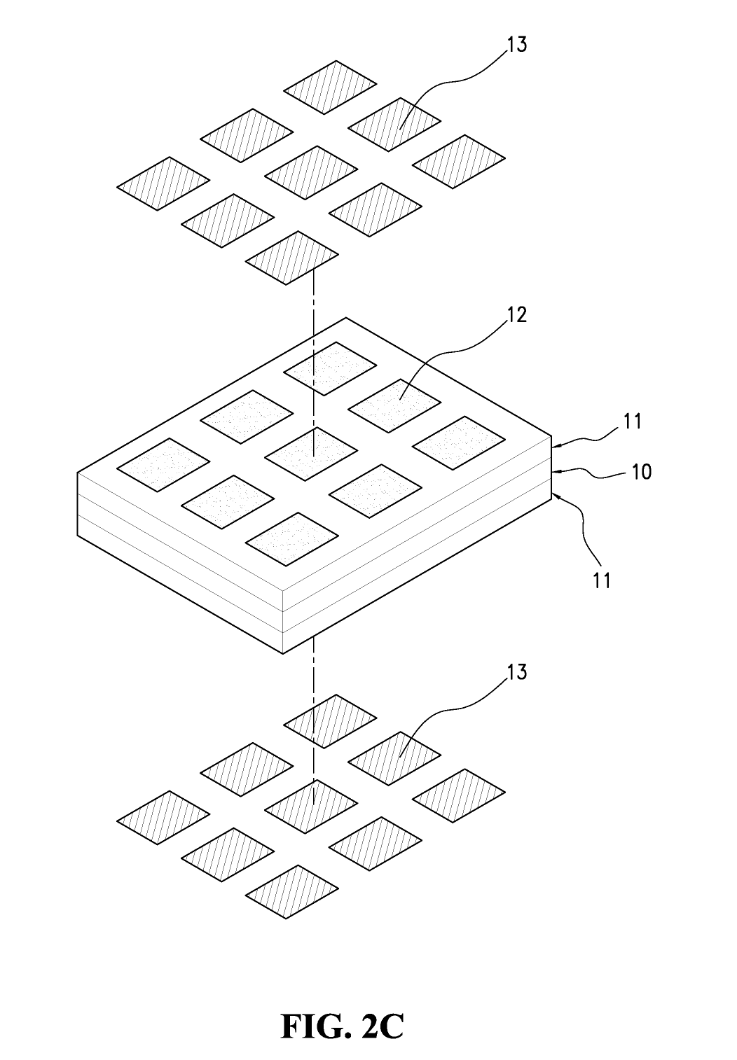

FIG. 1 is the flow diagram of a preferred embodiment of the present invention, and FIGS. 2a to 2c are skeleton drawings of the structure achieved by the manufacturing process in FIG. 1. As shown in FIG. 1, 2a, 2b and 2c, the manufacturing process of MEA layer for fuel cell in the present invention comprises step 101, 102 and 103, the description of which are separately given hereinbelow.

In step 101 while as shown in FIG. 2a, two racks 11 are separately pasted on the upper and lower surface of the proton exchange membrane 10. The proton exchange membrane 10 is a Nafion membrane. The racks 11 are rigid and are made from a kind of chemical resisting material with the characteristic of methanol/methanoic acid resisting, they can be made from a polymeric material such as resin and/or PP and/or PE. The area where the racks 11 are pasted on the upper and lower surface of the proton exchange membrane 10 is defined as the first area 10a while the other areas are defined as the second areas 10b, each area is divided into two corresponding parts: upper and lower. As a preferred embodiment, the present invention adopts resin for being spreaded on the first area 10a of the upper and lower surface of proton exchange membrane 10 while not a bit resin being spreaded on the second areas 10b of the upper and lower surface of proton exchange membrane 10.

In step 102 while as shown in FIG. 2b, catalyst 12 are spreaded on the second areas 10b of the upper and lower surface of the proton exchange membrane 10 by means of Nafion solution manufacturing process, the catalyst 12 is used as the catalyst of electrochemical reaction. For example, catalyst 12 is used as the catalyst of hydrogen-oxygen electrochemical reaction, and can be made from platinum/ruthenium alloys and/or platinum.

In step 103 while as shown in FIG. 2c, diffusion layers 13 are pasted on the second areas 10b of the upper and lower surface of the proton exchange membrane 10 which is spreaded with the catalyst 12 already, correspondingly. Each diffusion layer 13 is used for supporting the catalyst 12 and providing quality control of the gas and liquid on the surface of the proton exchange membrane 10 after hydrophobic treatment.

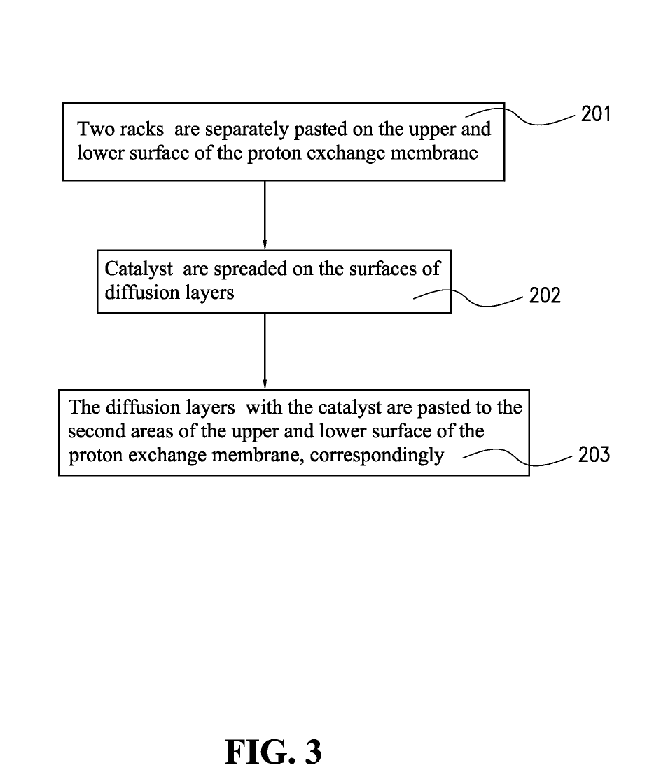

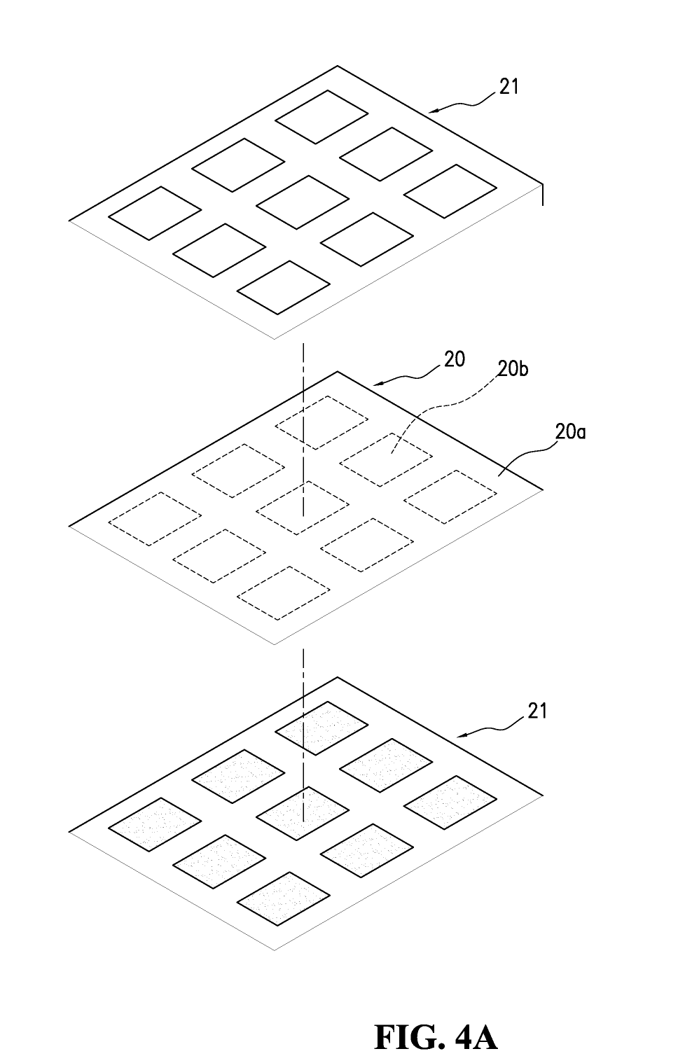

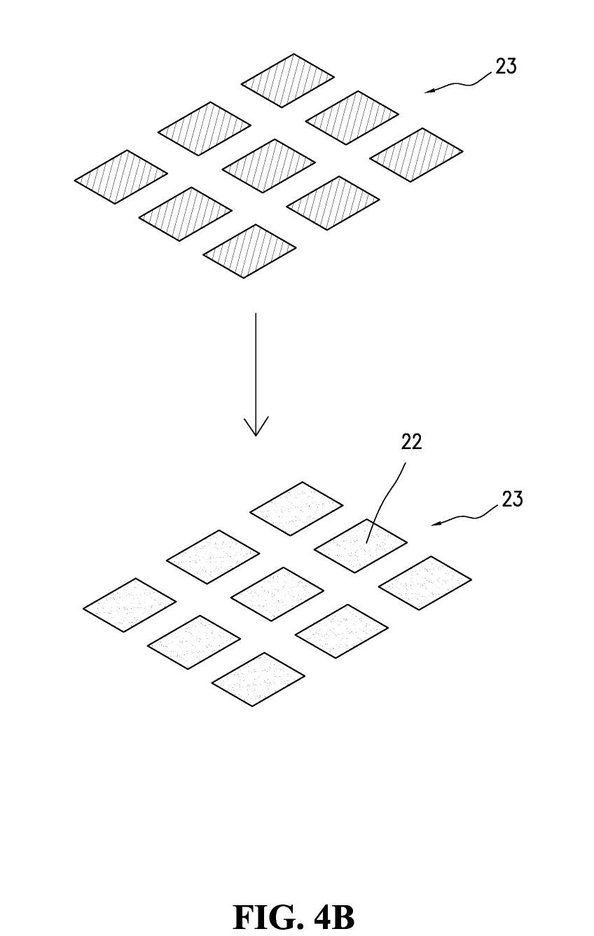

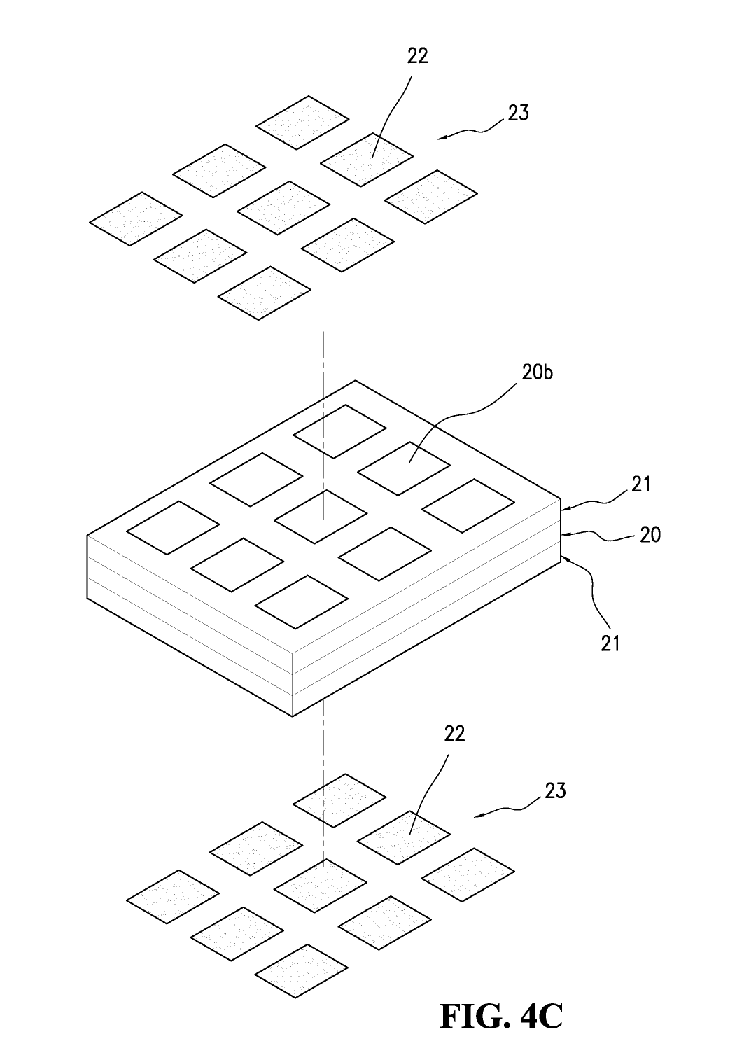

FIG. 3 is the flow diagram of another preferred embodiment of the present invention, and FIG. 4a to 4c are skeleton drawings of the structure achieved by the manufacturing process in FIG. 3. AS shown in FIG. 3, 4a, 4b and 4c, the manufacturing process of MEA layer for fuel cell in the present invention comprises step 201, 202 and 203, the description of which are separately given hereinbelow.

In step 201 while as shown in FIG. 4a, two racks 21 are separately pasted on the upper and lower surface of the proton exchange membrane 20. The proton exchange membrane 20 is a Nafion membrane. The rack 21 is rigid and is made from a kind of chemical resisting material with the characteristic of methanol/methanoic acid resisting, it can be made from a polymeric material such as resin and/or PP and/or PE. The area where the racks 21 are pasted on the upper and lower surface of the proton exchange membrane 20 is defined as the first area 20a while the other areas are defined as the second areas 20b, each area is divided into two corresponding parts: upper and lower. As a preferred embodiment, the present invention adopts resin for being spreaded on the first area 20a of the upper and lower surface of proton exchange membrane 20 while not a bit resin being spreaded on the second areas 20b of the upper and lower surface of proton exchange membrane 20.

In step 202 while as shown in FIG. 4b, catalyst 22 are spreaded on the surfaces of diffusion layers 23. The diffusion layer 23 is a carbon paper with a polarity of holes and it's used for supporting the catalyst 22 and providing quality control of the gas and liquid on the surface of the proton exchange membrane 20. the catalyst 22 is the catalyst of electrochemical reaction after hydrophobic treatment. For example, catalyst 22 is the catalyst of hydrogen-oxygen electrochemical reaction, and can be made from platinum/ruthenium alloys and/or platinum.

In step 203 while as shown in FIG. 4c, the diffusion layers 23 with the catalyst 22 on them are pasted to the second areas 20b of the upper and lower surface of the proton exchange membrane 20, correspondingly.

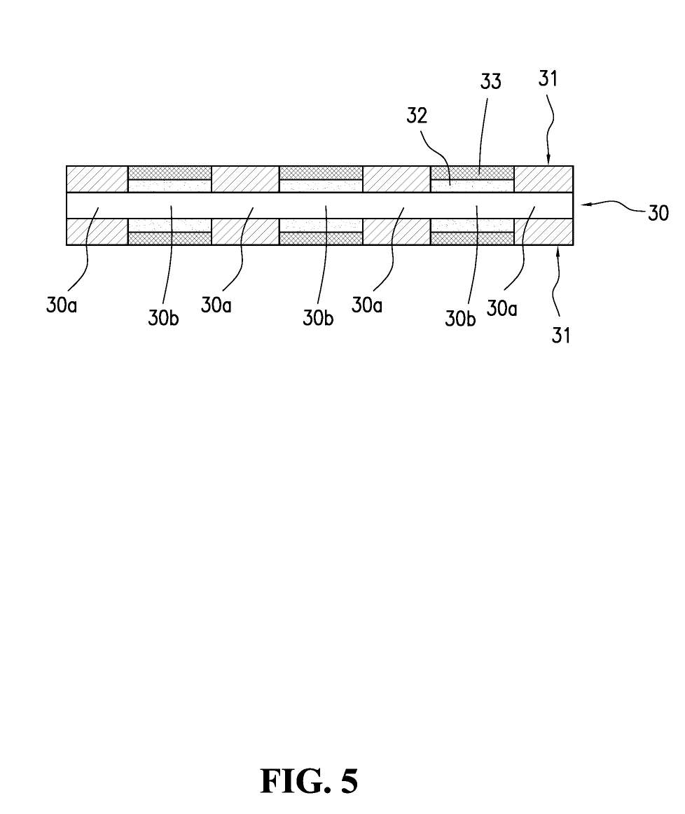

As shown in FIG. 5, it's the structure of MEA layer in the present invention achieved by the embodiment mentioned above. The first areas 30a and the second areas 30b are separately defined on the upper and lower surface of the proton exchange membrane 30. There are structures of racks 31 projected from the surface of the proton exchange membrane 30 in the first areas 30a and there are catalyst 32 and diffusion layer 33 separately set in the second areas 30b. Therefore, the area extensions or contractions of the second areas 30b of the proton exchange membrane 30 caused by the dryness or dampness are separately from each other, so no position shift will be arisen among second areas 30b. Subsequently, it's easy to correspond to the second areas 30b with catalyst 32 and diffusion layers 33 in the proton exchange membrane 30 for finishing the assembly in the following assembling process, and the MEA layer for electrochemical reaction of the fuel cell will be formed in the second areas 30b of the proton exchange membrane 30.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A manufacturing process of membrane electrode assembly layer for fuel cell, comprising the following steps:
pasting two racks separately on the upper and lower surface of a proton exchange membrane, said rack being rigid, and the area where said rack being pasted on the upper and lower surface of said proton exchange membrane being defined as the first area while the other areas being defined as the second areas, each said area being divided into two corresponding parts: upper and lower;
spreading catalyst on the second areas of the upper and lower surface of said proton exchange membrane, said catalyst being used as the catalyst of electrochemical reaction; and
pasting diffusions layers on the second areas of the upper and lower surface of said proton exchange membrane which being spreaded with said catalyst already.

2. The manufacturing process of membrane electrode assembly layer for fuel cell claimed in claim 1, wherein said proton exchange membrane is a Nafion membrane.

3. The manufacturing process of membrane electrode assembly layer for fuel cell claimed in claim 1, wherein the step of spreading said catalyst on the second areas of the upper and lower surface of said proton exchange membrane is to adopt Nafion solution manufacturing process.

4. The manufacturing process of membrane electrode assembly layer for fuel cell claimed in claim 1, wherein the step of pasting said diffusion layer on the second areas of the upper and lower surface of said proton exchange membrane is to adopt Nafion solution manufacturing process in the manufacturing process that.

5. The manufacturing process of membrane electrode assembly layer for fuel cell claimed in claim 1, wherein said rack is made from a kind of chemical resisting material with the characteristic of methanol/methanoic acid resisting.

6. The manufacturing process of membrane electrode assembly layer for fuel cell claimed in claim 5, wherein said rack is made from a polymeric material such as resin and/or PP and/or PE.

7. The manufacturing process of membrane electrode assembly layer for fuel cell claimed in claim 1, wherein said catalyst is the catalyst of hydrogen-oxygen electrochemical reaction.

8. The manufacturing process of membrane electrode assembly layer for fuel cell claimed in claim 7, wherein said catalyst is made from platinum/ruthenium alloys and/or platinum.

9. The manufacturing process of membrane electrode assembly layer for fuel cell claimed in claim 1, wherein said diffusion layer is used for supporting said catalyst and providing quality control of the gas and liquid on the surface of said proton exchange membrane after hydrophobic treatment.

10. A manufacturing process of membrane electrode assembly layer for fuel cell, comprising the following steps:
pasting two racks separately on the upper and lower surface of a proton exchange membrane, said rack being rigid, and the area where said rack being pasted on the upper and lower surface of said proton exchange membrane being defined as the first area while the other areas being defined as the second areas, each said area being divided into two corresponding parts: upper and lower;
spreading catalyst on the surface of each diffusion layer, said each diffusion layer being a carbon paper with a polarity of holes, said catalyst is the catalyst of electrochemical reaction; and
pasting said diffusion layers with said catalyst to the second areas of the upper and lower surface of said proton exchange membrane.

11. The manufacturing process of membrane electrode assembly layer for fuel cell claimed in claim 10, wherein said proton exchange membrane is a Nafion membrane.

12. The manufacturing process of membrane electrode assembly layer for fuel cell claimed in claim 10, wherein the step of spreading said catalyst on the surface of said diffusion layer is to adopt the Nafion solution manufacturing process.

13. The manufacturing process of membrane electrode assembly layer for fuel cell claimed in claim 10, wherein the step of pasting said diffusion layer with said catalyst to the second areas of the upper and lower surface of said proton exchange membrane is to adopt the Nafion solution manufacturing process.

14. The manufacturing process of membrane electrode assembly layer for fuel cell claimed in claim 10, wherein said rack is made from a kind of chemical resisting material with the characteristic of methanol/methanoic acid resisting.

15. The manufacturing process of membrane electrode assembly layer for fuel cell claimed in claim 14, wherein said rack is made from polymeric material such as resin and/or PP and/or PE.

16. The manufacturing process of membrane electrode assembly layer for fuel cell claimed in claim 10, wherein said catalyst is the catalyst of hydrogen-oxygen electrochemical reaction.

17. The manufacturing process of membrane electrode assembly layer for fuel cell claimed in claim 16, wherein said catalyst is made from platinum/ruthenium alloys and/or platinum.

18. The manufacturing process of membrane electrode assembly layer for fuel cell claimed in claim 10, wherein said diffusion layer is used for supporting said catalyst and providing quality control of the gas and liquid on the surface of said proton exchange membrane after hydrophobic treatment.

19. A structure of membrane electrode assembly layer for fuel cell, comprising:
a proton exchange membrane, with a first area and a second area separately being defined on its upper and lower surface;
two racks, separately pasted on the first area of the upper and lower surface of said proton exchange membrane; and
catalyst and diffusion layers, being set on said second areas, and said catalyst being spreaded on said diffusion layers.

20. The structure of membrane electrode assembly layer for fuel cell claimed in claim 19, wherein said proton exchange membrane is a Nafion membrane.

21. The structure of membrane electrode assembly layer for fuel cell claimed in claim 19, wherein said racks are made from a kind of chemical resisting material with the characteristic of methanol/methanoic acid resisting.

22. The structure of membrane electrode assembly layer for fuel cell claimed in claim 21, wherein said racks are made from polymeric material such as resin and/or PP and/or PE.

23. The structure of membrane electrode assembly layer for fuel cell claimed in claim 19, wherein said catalyst is the catalyst of hydrogen-oxygen electrochemical reaction.

24. The structure of membrane electrode assembly layer for fuel cell claimed in claim 23, wherein said catalyst is made from platinum/ruthenium alloys and/or platinum.

25. The structure of membrane electrode assembly layer for fuel cell claimed in claim 19, wherein said diffusion layer is used for supporting said catalyst and providing quality control of the gas and liquid on the surface of said proton exchange membrane after hydrophobic treatment.
